(19) United States
(12) Patent Application Publication
(10) Pub. No.: US 2019/0322339 A1
(43) Pub. Date: Oct. 24, 2019

(54) Method and Product for Application of Wax To A Surfboard

(71) Applicant: Christopher Dorny, San Marcos, CA (US)

(72) Inventor: Christopher Dorny, San Marcos, CA (US)

(21) Appl. No.: 15/959,174

(22) Filed: Apr. 21, 2018

(51) Int. Cl. B63B 35/79; B05C 17/12

(52) U.S. Cl. CPC B63B 35/7933; A63C 11/08; B05C 17/12

(57) ABSTRACT

A method of applying wax to a slippery surface such as a surfboard in various patterns to create traction. A wax design is applied to a substrate surface. The wax design can easily be applied directly to the surfboard and the substrate removed, leaving the wax design affixed to the surfboard. The wax can easily be removed from the surfboard surface when desired.

### CROSS-REFERENCE TO RELATED DOCUMENTS

The present invention claims priority to a U.S. provisional patent application 62/488,063, filed Apr. 21, 2017 and entitled “Method and Product for Application of Wax To A Surfboard”, disclosure of which is incorporated herein in its entirety at least by reference.

### BACKGROUND OF THE INVENTION

### 1. Field of the Invention

For many years, surfers have used wax on the top surface of a surf board to avoid slipping when performing maneuvers on a wave. Typically, this wax is purchased from a surf supply store and comes in a block. Surfers spend a significant amount of time getting the wax the way they want it. They first apply a basecoat of wax with a harder wax and then put on a top coat wax that is optimal for the water temperature where they are surfing that day. After several surf sessions, the wax becomes discolored, dirty, some falls off, sun melts it and it becomes unsightly. In this case, the wax is removed and new wax is applied. Many hours can be spent getting the wax to the users liking. Surfers want to get the perfect wax applied on the board so that they can surf well without slipping. They don't mind spending the time to do it right, but they would like to achieve the perfect wax job in the quickest amount of time.

Some surfers even use multiple colors. Surfboards are also used for marketing purposes. Surfers can be sponsored by companies and in return for getting free equipment, the sponsor gets their logo placed on the surfer's board. Usually, the logos are placed on the bottom of the board because wax will not cover up these logos and they are easy to see when maneuvers are performed. Having a well decorated board usually means that the surfer is really good since he has a lot of sponsors. Having a unique board is almost as important as being able to do very difficult maneuvers. Artists have been able to individually apply wax in very time consuming methods to make innovative designs on boards, but the average surfer does not have the ability, time or equipment to accomplish this.

A better way of applying the perfect wax job to a board is needed. This should make the board look good as well as provide the anti-slip necessary to stay connected to the board.

### BRIEF SUMMARY OF THE INVENTION

The invention provides a novel method for applying wax to a surfboard. More particularly, the method involves creating a wax design on a substrate, such as paper. The wax can be manipulated during or after application to the substrate to provide a desired thickness and shape. Different waxes, having various properties, including colors, can be applied to the substrates in different areas to create patterns. The patterns may be such to improve grip. They may also provide esthetically pleasing designs or logos, as are provided with decals. The wax design can be directly applied to the surfboard and the substrate removed, leaving the wax design affixed to the surfboard. Multiple layers of wax can be applied to create different surface shapes.

The invention further includes a product for application to a surfboard to provide a non-slip surface. The product includes a wax layer having a design to be applied to a surfboard. The product further includes at least one backing layer. A backing layer may be formed on both sides of the wax layer.

### BRIEF DESCRIPTION OF THE SEVERAL VIEWS OF THE DRAWINGS

FIG. 1 shows the wax patterns when applied to a surfboard

FIGS. 2 A, and B show a show a simple device for making embodiments of the present invention before removal of unwanted wax

FIGS. 3 and 4 show a device for making preferred embodiments of the present invention before removal of unwanted wax FIGS. 5 A, and B are section views of preferred embodiments of the present invention before removal of unwanted wax

FIGS. 6 A, and B are section views of preferred embodiments of the present invention for a single layer of wax

FIGS. 7 A, and B are section views of preferred embodiments of the present invention for multiple layers of waxg. 6 shows a remote controller in an embodiment of the invention.

FIGS. 8 A, B, C and D are section views of preferred embodiments of the present invention utilizing stencils

FIG. 9 is the section views using the hot wax press method to make a sheet of wax FIGS. 10A and B is the section views showing the layers after being applied to the surfboard

FIG. 11 is the section view of the substrate and uniform single layer of wax

### DETAILED DESCRIPTION OF THE INVENTION

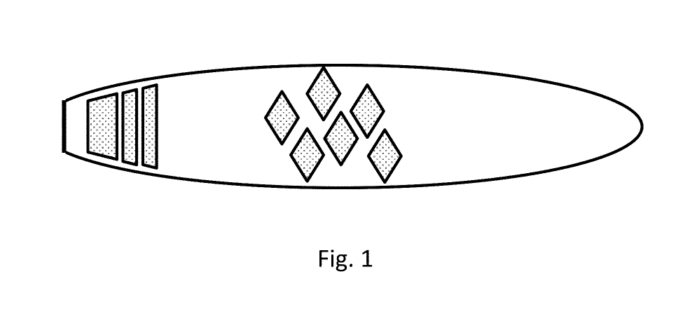

The present invention provides a method and product for creating designs from wax such that they can be applied to a surfboard. The designs are functional and provide a non-slip gripping surface, as well as providing a stylish addition to the board. According to the invention, wax designs are created on a substrate. Various substrate materials may be used. After the wax design is formed on the substrate, it can be transferred to the surfboard at a location desired by the surfer. FIG. 1 is a top view of a surfboard showing where the wax preferably would be applied. This is how it would look once the wax is attached to the surfboard and the substrate is removed.

There are two methods of fabricating 3D wax designs on a substrate. The first approach is to create a uniform layer of wax on a substrate and then remove the wax that is unwanted leaving the desired wax design on the substrate. The second approach is to start with a clean substrate and selectively place wax on the substrate where the wax designed is desired. The embodiments described utilize these methods but there may be other ways of removing unwanted wax or putting wax onto a substrate which could be used to fabricate this invention.

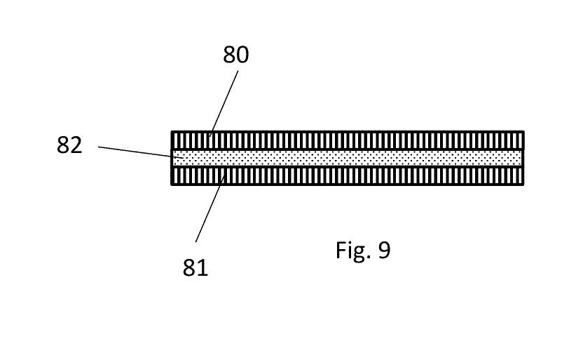

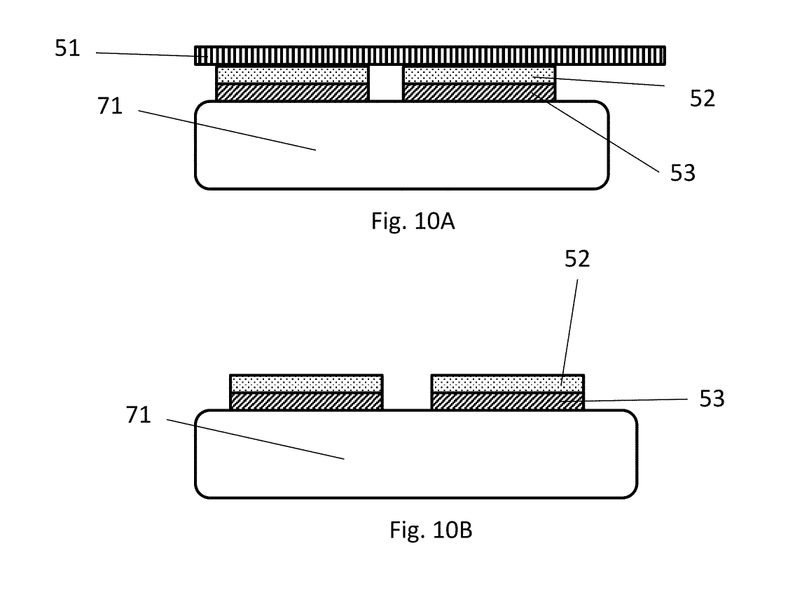

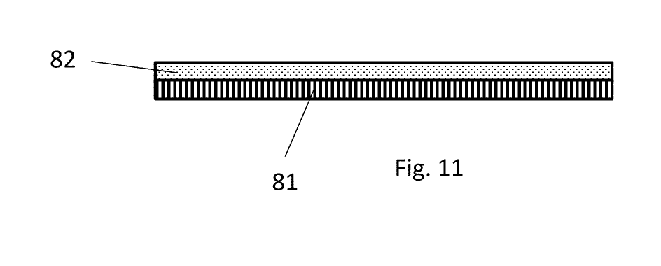

The present disclosure provides various embodiments of generating the wax design on a substrate backing. In one embodiment, the method for applying the wax to a substrate includes heating the wax to its melting point and applying the heated material onto a substrate. The substrate may include paper, wax paper or other comparable substrates/surfaces. A method to create a uniform layer of wax on a substrate is to heat wax to the melting point and pour this melted wax 82 onto a substrate 81 and press this down with another piece of substrate 83 on top. By using a flat surface below and a flat surface on top, the pressure allows a desired thin layer of wax to be formed (about 1 mm thick). A cross section of this configuration is shown in FIG. 9 which shows that the resulting sheet contains two pieces of substrate (81 and 83) with wax 82 in between them. One layer of the substrate is removed, leaving a layer of wax 82 with one substrate layer 81 as shown in FIG. 11. This wax and substrate layer is then put into a machine which cuts out the desired design by only cutting the wax but leaving the substrate uncut. The unwanted wax is removed to only leave the wax design desired for the board. The machine can be any automated cutting machine, such as the Cameo Silhouette. This is very similar to the way that vinyl is used to cut out a vinyl design without cutting the substrate underneath and then removing the unwanted vinyl.

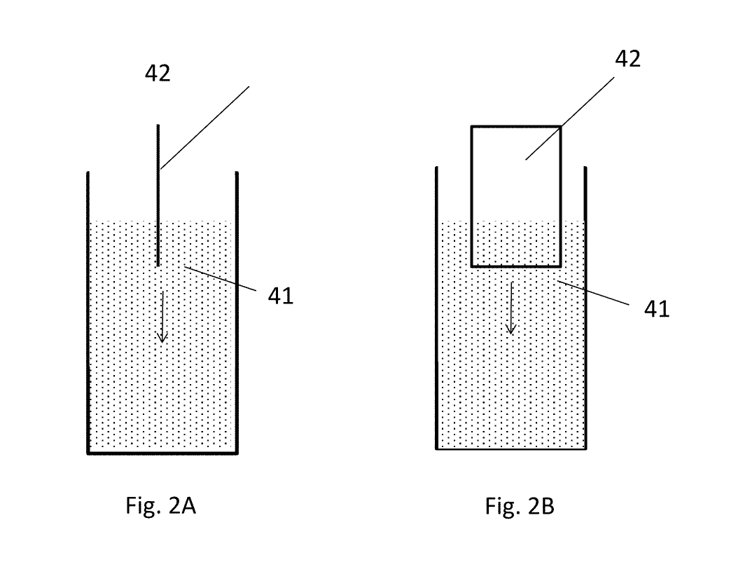

In another embodiment, the method includes dipping the substrate in melted wax. FIG. 2A and FIG. 2B are drawings of another simple way of creating a uniform layer of wax onto a substrate by dipping the substrate 42 in melted wax 41 multiple times until the wax layer is the desired thickness of about 1 mm. FIG. 2A is the side view and FIG. 2B is the front view. Using this dipping method, both sides of the substrate would have wax attached. To achieve wax on only one side (as desired), two layers of the substrate 51 are bonded together using a temporary adhesive and then dipped in the melted wax. Once the desired thickness is achieved, the resulting side view is shown in FIG. 5A. There are two layers of substrate 51 in between two layers of wax 52. These substrate layers are then separated forming two separate sheets of a single substrate layer 51 and a single wax layer 52 as shown in FIG. 5B. These would then be cut out using an automated cutting system.

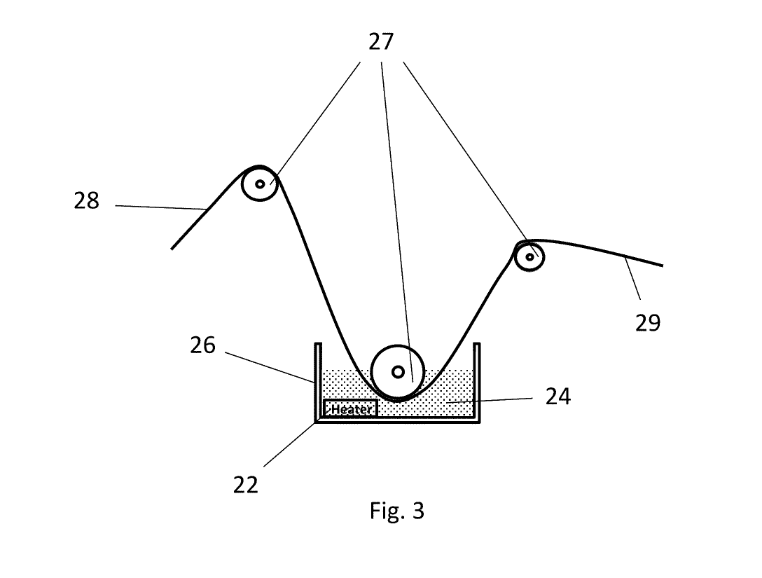

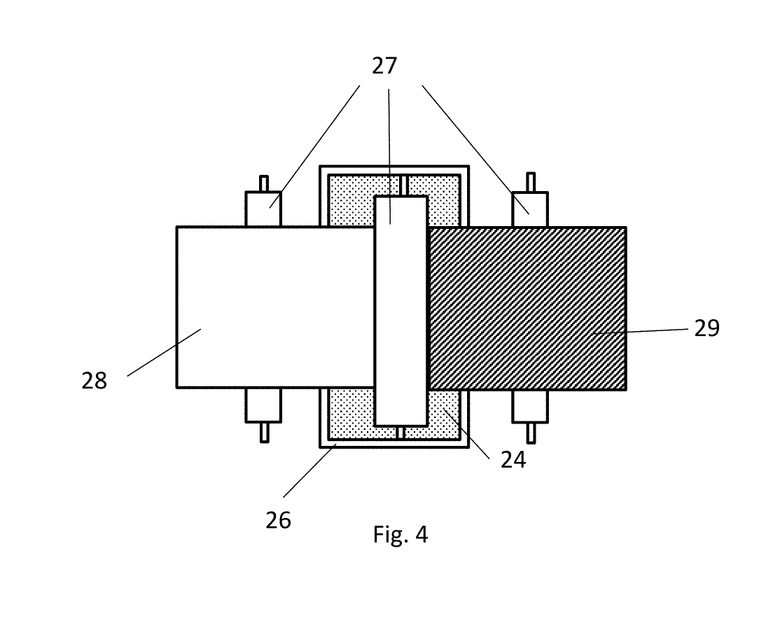

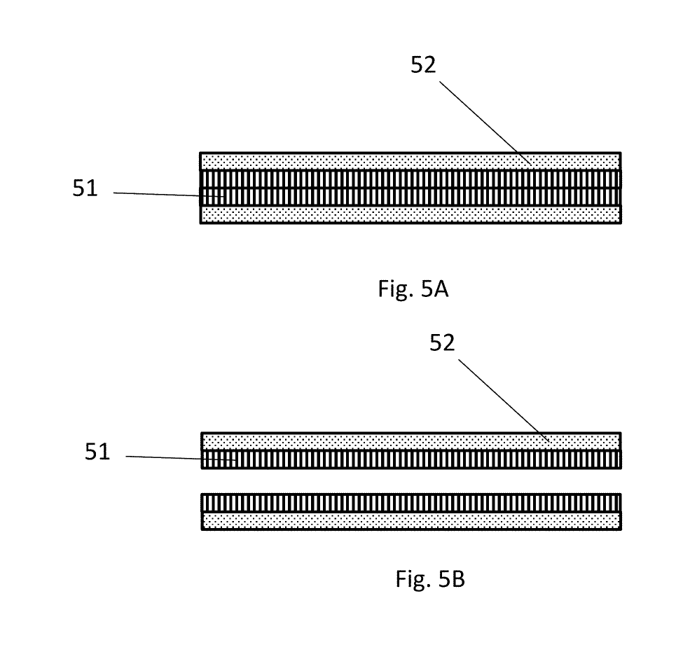

Only making one sheet of paper at a time can be time consuming and costly. In another embodiment, one could utilize a continuous substrate feed will allow a large number of sheets to be manufactured rapidly. FIG. 3 is the side view and FIG. 4 is the top view which shows how a configuration for a continuous roll of a substrate could be coated in wax. A heater 22 maintains a pool of wax 24 at a temperature of about 180 degrees F. in vat 26. Two layers of substrate that are bonded together 28 are fed through the vat of molten wax and as it moves out of the wax, the wax cools creating two layers of substrate in between two layers of wax 29. This results in a set of layers of substrate and wax as shown in FIG. 5A. These two layers of the substrate are separated leaving one layer of substrate with one layer of wax as shown in FIG. 5B. These sheets can have the wax cut out by machines to make the designs.

In another embodiment, another way of creating the wax designs on a flexible base is to use a 3D printer. A hot end that can utilize low temperatures in the 60-100 degrees Celsius is needed. The substrate being printed on needs to be held down so that as the wax cools it does not deform the shape. A low temperature hot plate could be used for this to avoid any deformities of the design as well.

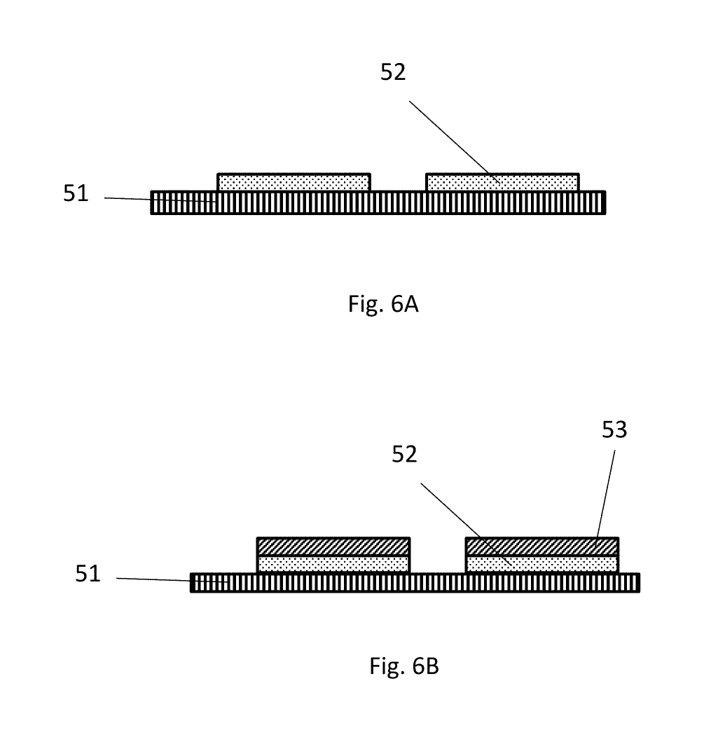

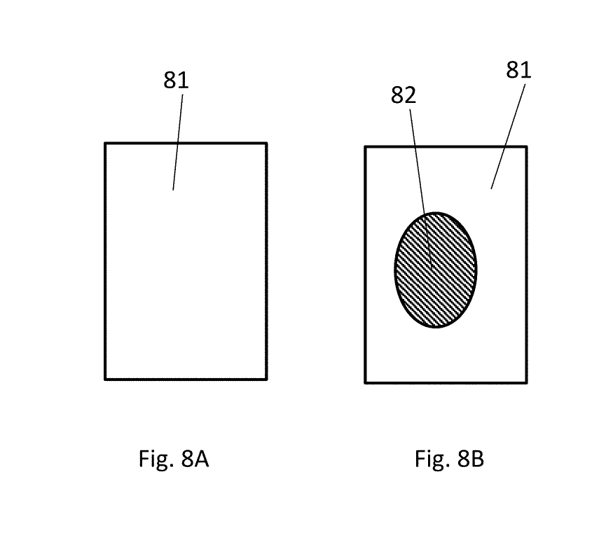

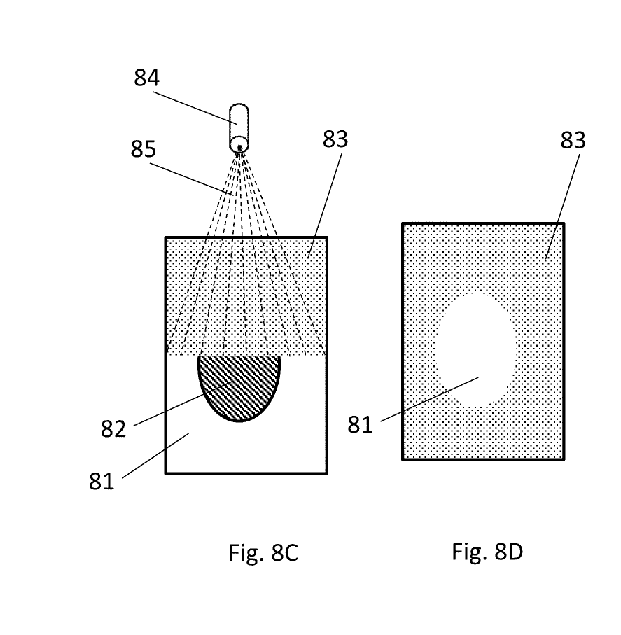

In another embodiment, a stencil method can also be used. This method utilizes a substrate 81 shown in FIG. 8A. A stencil 82 is laid on top of the substrate as shown in FIG. 8B. The stencil can be made of a variety of materials. FIG. 8C demonstrates the use of a pressurized nozzle 84, which sprays melted wax or liquid wax 85 onto the substrate surface 81 as well as the surface of the stencil 82. Melted wax as well as wax emulsions have been used with this method. Stenciling produces an image or pattern by applying wax to a substrate surface over an intermediate object with designed gaps in it which create the pattern or image by only allowing the wax to reach some parts of the substrate surface. FIG. 5A shows a substrate by itself. FIG. 5B shows the substrate with a stencil sitting on top of it. FIG. 5C shows that wax is sprayed onto the configuration in FIG. 5B which covers this entire surface and coating the stencil and the substrate. Where the stencil is sitting on the substrate, wax is not touching this part of the substrate. FIG. 5D shows that when the stencil is removed, the substrate is left with wax attached in only the locations that were not covered by the stencil. The result is a substrate 51 with a wax design with gaps in between sections of wax as shown in FIG. 6A.

In another embodiment, a way to make the flat sheets of wax is to use a mechanical press to make a thin layer of wax. This can keep the wax from changing any of its physical properties. A pressing machine is needed for this and the backing or wax paper is added after the press. The design can then be cut out using the robotic cutting tool. The wax shapes 51 cut out are then assembled onto a substrate 52 as shown in FIG. 6A. A layer of adhesive 53 can be applied to the wax design by spraying, rolling onto, or using any other methods to achieve the configuration shown in FIG. 6B.

Once the wax design is created on the substrate, the design needs to be connected to the surfboard. Some types of surf wax stick easily to a surfboard while others do not. Harder waxes like base coat need something to help them stay attached to the board. FIG. 6B shows how a pressure sensitive adhesive 53 or other type of adhesive can be sprayed onto the wax layer 52 using a stencil. Once cured, this can be shipped to a customer and placed on top of a surfboard as shown in FIG. 10A. Pressure is gently applied to bond the pressure sensitive adhesive to the surfboard. The substrate 51 can then be removed leaving just the adhesive and wax attached to the surfboard as shown in FIG. 10B. A layer of top coat wax can then be applied to the design. This ensures that the type of wax touching a surfers foot is optimized for the location where the surfer is surfing. In colder water, a softer top coat wax can be used and in warmer water a harder top coat wax can be applied on top of the design.

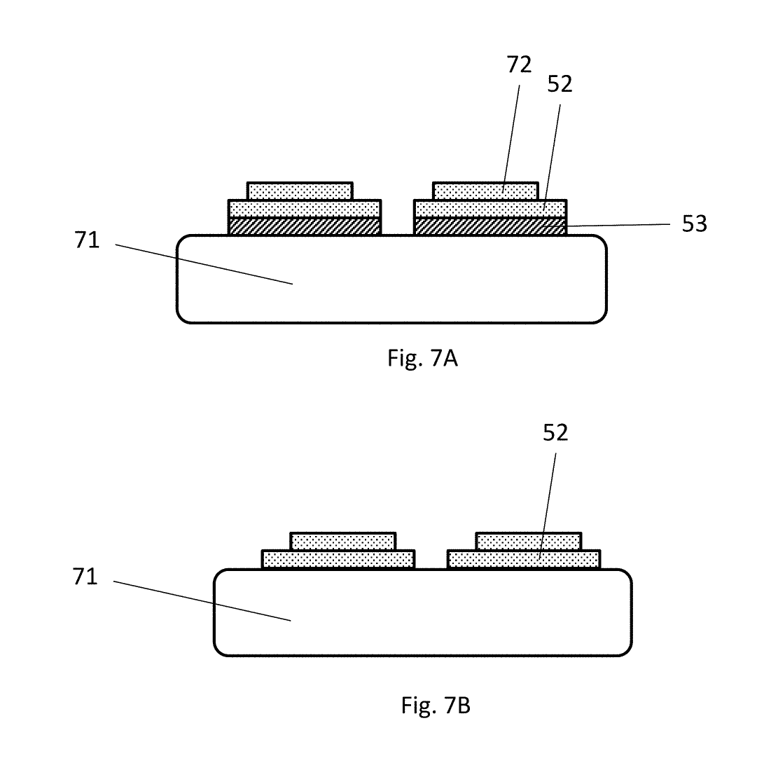

Various methods can be used to create wax designs on a substrate. The wax can be manipulated during or after application to the substrate to provide a desired thickness and shape. Different waxes, having various properties, including colors, can be applied to the substrates in different areas to create patterns. The patterns may be such to improve grip. They may also provide esthetically pleasing designs or logos, as are provided with decals. The wax design can be directly applied to the surfboard and the substrate removed, leaving the wax design affixed to the surfboard. Multiple layers of wax can be applied to create different surface shapes. FIGS. 10A and 10B show how a single layer of wax can be applied to a surfboard. Once this is accomplished, a single layer of wax FIG. 6A can be placed on top of the wax design in FIG. 10B. By applying pressure, this bonds wax layer 72 to layer 52. The substrate can then be removed leaving the configuration shown in FIG. 7A with a surfboard 71 with a layer of adhesive 53, layer of wax 52, and another layer of wax 72 on top of it. If the type of wax is sticky enough to not require an adhesive to stick to the surfboard, the multi-layer wax design configuration shown in FIG. 7B can be used.

The result of any of these methods is the creation of a 3D wax design on a substrate. This design can then be shipped to a customer anywhere in the world and attached to a customers surfboard. The substrate is then removed.

There are many slippery surfaces, in addition to a surfboard that this method would be useful for. Stand up paddleboards, kite surfing, boats, wind surfboards, and even showers could utilize this. Skateboards also apply wax for doing tricks on the bottom of the deck.

Preferred embodiments of the present embodiments may be described by reference to the drawings.

The present invention provides a method and product for creating designs from wax such that they can be applied to a surfboard. The designs are functional and provide a non-slip gripping surface, as well as provide an artistic look to the board. According to the invention, wax designs are created on a substrate. Various substrate materials may be used. After the wax design is formed on the substrate, it can be transferred to the surfboard at a location desired by the surfer.

Using the first approach for applying the wax to a substrate is to heat wax to the melting point and pour this onto a paper, wax paper or other surface and press this down with another piece of wax paper on top. By using a flat surface below and a flat surface on top, the pressure allows a desired thin layer of wax to be formed (about 1 mm thick). The wax layer and one or both paper layers are then put into a machine which cuts out the desired design. The unwanted wax is removed to only leave the wax design desired for the board. The machine can be any automated cutting machine, such as the Cameo Silhouette.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the invention is to cover all modifications, equivalents, and alternatives falling within the spirit and scope of the invention as defined herein. For example, while the invention is described herein with a specific focus on the use of pressure sensitive adhesive, other adhesive materials such as soft wax or a rubber based adhesive could be used.

The foregoing description of the present invention has been presented for the purpose of illustration and is not intended to limit the invention to the precise form disclosed. It is understood that many modifications and changes may be effected by those skilled in the art. For example, the substrate could be made of many materials such as paper, wax paper, and sheet plastic. In place of the pressure sensitive adhesive, soft wax or a rubber based pressure sensitive adhesive could be used. Accordingly, it is intended by the appended claims to cover all modifications and changes as fall within the true spirit and scope of the invention.

1. A method for applying wax to a surfboard comprising the steps of:
creating a design in wax on a substrate;
adhering the design in wax to the slippery surface; and
removing the substrate.

2. The method of claim 1, wherein the slippery surface is a surfboard

3. The method of claim 1, wherein the step of creating a design in wax includes the steps of:
depositing wax onto a first substrate;
positioning a second substrate onto the wax to form a layer of wax between the two substrates; and
cutting away portions of the wax and substrates to create the design in the wax layer.

4. The method of claim 1, wherein the step of creating a design in wax includes the step of:
depositing wax on portions of the substrate.

5. The method of claim 3, wherein the step of depositing wax includes the step of:
preventing wax from being deposited on portions of the substrate.

6. The method of claim 4, wherein the preventing step includes the step of:
using a stencil to prevent wax from being deposited on portions of the substrate.

7. The method of claim 1, wherein the step of creating a design in wax includes the step of:
dipping a substrate in a liquid wax.

8. The method of claim 1, wherein the step of creating a design in wax includes the steps of:
creating a first design on the substrate with a wax having a first set of properties, and
creating a second design on the substrate with a wax having a second set of properties.

9. The method of claim 1, further comprising the steps of:
creating a second design in wax having a second set of properties on a second substrate;
adhering the second design in wax to the surfboard; and
removing the second substrate.

10. The method of claim 8 wherein the first design and the second design are applied to different parts of the surfboard.

11. The method of claim 8, wherein the second design is applied to the surfboard over at least a portion of the wax in the first design.

12. A method for creating a wax layer to be applied to a surfboard, comprising the steps of:
forming a layer of wax on at least one substrate;
removing portions of the wax to form a design in the layer of wax on the at least one substrate.

13. A product for applying wax to a surfboard comprising:
a substrate, and
a layer of wax on the substrate.

14. The product of claim 12, wherein the layer of wax includes a design.

15. The product of claim 13, wherein the layer of wax has spaces without wax forming the design.

16. The product of claim 13, wherein the layer of wax includes at least two waxes, having at least one different property from the others, positioned at different locations on the substrate.
